(19) United States
(12) Patent Application Publication
(10) Pub. No.: US 2006/0080913 A1
(43) Pub. Date: Apr. 20, 2006

(54) Wall made of panels used in pre-manufactured construction

(75) Inventor: Gilmar da Costa Lima, Curitiba/PR (BR)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: MVC Componentes Plasticos Ltda.

(21) Appl. No.: 11/008,518

(22) Filed: Dec. 9, 2004

(30) Foreign Application Priority Data
Oct. 18, 2004 (BR) MU 8402471-2

(51) Int. Cl. E06B 1/04

(52) U.S. Cl. 52/204.1

(57) ABSTRACT

This invention provides a new wall arrangement in panels composed of glass wool and fire resistant thermal and acoustical insulating material, adequate for any kind of land and weather condition, to create a habitable environment that may be utilized in many applications such as houses, attendance stations, schools, first aid stations, motels and others. The objective of this invention is to present the conception of a modular wall which comprises a structure composed of a sheet of glass wool, with a wooden frame core and the upper part designed to support cabinets, exhaust fans, and other utensils, offering good mechanical resistance, and receiving in the interior of the hollow areas of the wooden frame, a layer of expanded polystyrene, with grooves to receive the ribs of rock wool. To complete its composition, the structure also has rock wool internal panels, wooden frame with the upper area, a new layer of expanded polystyrene, and completing the assembly a plate of glass wool is added.

### FIELD OF THE INVENTION

This invention relates to a new wall arrangement in panels composed of glass wool and fire resistant thermal and acoustical insulating material, adequate for any kind of land and weather condition, to create a habitable environment that may be utilized in many applications such as houses, attendance stations, schools, first aid stations, motels and others.

### BACKGROUND OF THE INVENTION

Nowadays, all kinds of materials are used to fabricate modular wall panels for houses, such as dry wall, concrete, laminated plastic, among others. However, these modules present some inconveniences when exposed to changes in weather conditions. In addition to that, the handling of the existing modular walls is very difficult due to their elevated weight and the material used to install them generates too much waste, producing a dirty job site and a harmful environment to the workers' health.

The objective of this invention is to present the conception of a modular wall which produces a habitable environment with a finishing of good quality, low cost, quick installation, and with no harmful waste to the environment and the workers. This is achieved through a new conception of modular construction which comprises a pre-fabricated construction based on structural walls that may be used as external and internal walls, fabricated in panels composed of glass wool and a filling consisting of an insulating and thermo-stable material, producing a double decker sandwich with two layers of expanded polystyrene, one internal layer of rock wool and a lining of plastic plates reinforced with glass wool, being finally structured by a wooden woof and rock wool ribs, forming a fire resistant structure, which assures thermal and acoustical comfort and excellent durability. The walls do not require painting, but they take any type of usual finishing.

### BRIEF DESCRIPTION OF THE DRAWINGS

In order to help understand the new arrangement of pre-fabricated wall panels, objective of this utility model, as well as the advantages of the process, the following explanations were added, accompanied by figures:

FIG. 1 is an exploded perspective of the proposed panel;

FIG. 2 is a cross section of the proposed panel;

FIG. 3 is an upper view of the panel;

FIGS. 4 THROUGH 10 are perspective views of the panel including sequence of fabrication and composition; and

FIG. 11 is a front view of the panel. including groove.

### DETAILED DESCRIPTION OF THE INVENTION

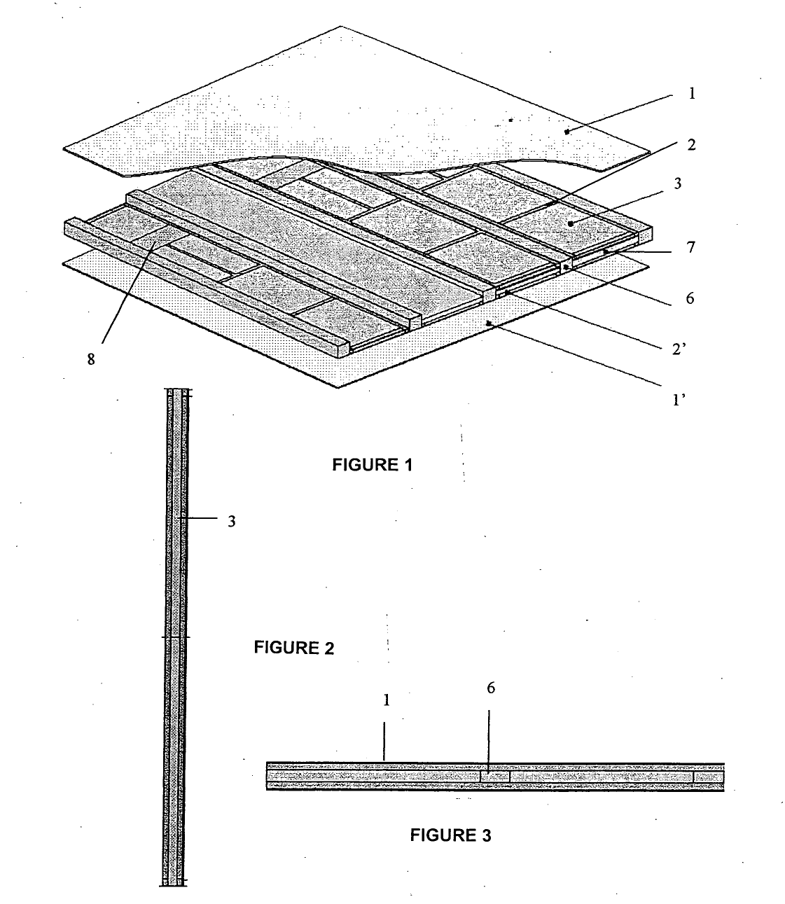

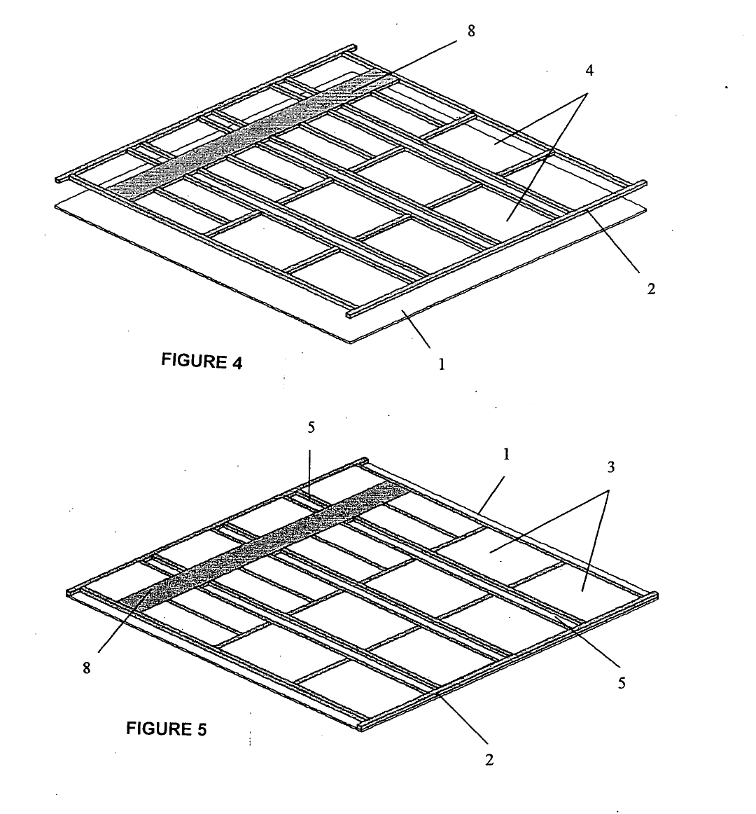

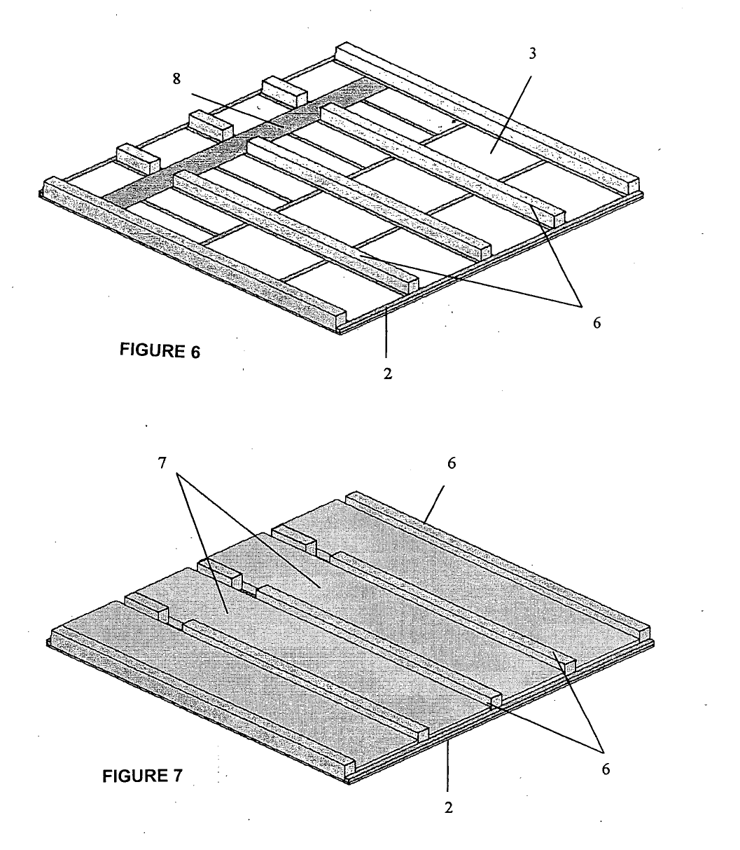

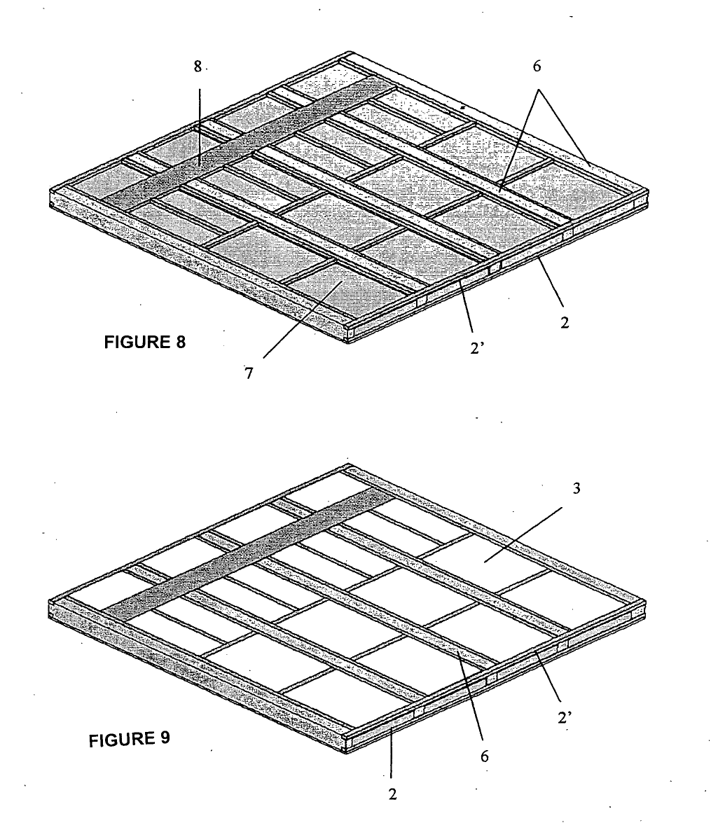

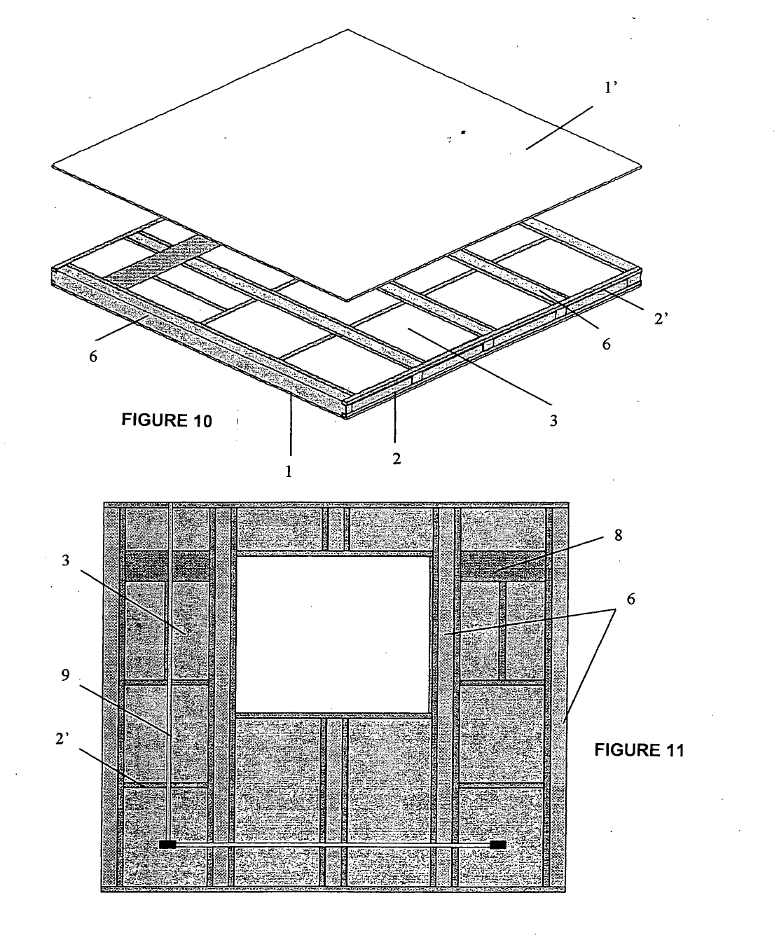

According to FIGS. 1 through 11 he arrangement of the wall in panels comprises a structure composed of a sheet (1) of glass wool with a wooden frame core (2) and the upper part (8) designed to support cabinets, exhaust fans and other utensils, offering good mechanical resistance, and receiving in the interior of the hollow areas (4) of the wooden frame (2), a layer of expanded polystyrene (3), with grooves (5) to receive the ribs of rock wool (6). To complete its composition, the structure also has rock wool internal panels (7), wooden frame (2′) with the upper area (8), a new layer of expanded polystyrene (3), and to complete the assembly a plate (1′) of glass wool is added.

Panels with grooves (9) for electrical installations are also available in different shapes to accommodate switches, outlets, embedded in the proper place.

For walls with doors, windows or other elements that require special openings, the same arrangement of the modules of the wood woof and the rock wool ribs is adopted, thus allowing openings according to the requirements.

The wood framing work in the rock wool and expanded polystyrene occurs before the assembly of the panel, by means of clamps, which attach the rock wool to the two frames.

The plates (1) and (1′) of glass wool are made through an extrusion process, in which the raw material, consisting of gel coat or pigment, low viscosity polyester resin with tri-hydrated alumna (aluminum oxide) and glass wool is dispensed over a polyester film which slides on a flat surface. The components of the raw material are dispensed in different phases over the polyester film, and after that, another polyester film is placed on top of the first layer and the raw material; in the next phase the “sandwich” is compacted by means of cylinders that determine the thickness of the plate. After the material is compacted, the plates travel a certain distance over a heated table to complete the cure, transforming the “sandwich” in a rigid plate.

In order to transform the plates (1) and (1′) into panels, a core is added and the materials, including plate (1)+core prepared according to the above description+glass wool plate (1′), are glued through a vacuum or pressing process. The process starts with the sandpapering of the internal faces of the two plates (1) and (1′) which will be glued together. The glass wool plate (1) with the adhesive, then the core composed of the wood (2) and (2′), rock wool ribs (6), internal panel in rock wool (7) and expanded polystyrene (3), are placed in the press; then the set is completed with the second glass wool plate (1′), and finally the panel is submitted to vacuum for the pressing and gluing operations.

The composition in plates (1 and 1′) and core (2, 2′, 3, 6, and 7) produces a panel with fire and mechanical resistance, thermal and acoustical comfort, and waterproof, all in accordance with standard requirements.

What is claimed is:

1. A wall in compound panels for pre-fabricated construction, comprising a structure composed of a glass wool plate with a core formed by a wooden frame, provided with an upper area designed to support cabinets, exhaust fans, and other utensils, and which receives, in the interior of the hollow areas of the wooden frame, a layer of expanded polystyrene, with grooves to receive the ribs of rock wool. To complete its composition, the structure also has rock wool internal panels, wooden frame with the upper area, a new layer of expanded polystyrene, and completing the assembly, a plate of glass wool is added.

2. The wall in compound panels for pre-fabricated construction according to claim 1; comprising alternatively presenting the proposed panel provided with grooves for electrical installations in different shapes to accommodate switches, outlets, embedded in the proper place.

3. The wall in compound panels for pre-fabricated construction according to claim 1, comprising a core with a framework in rock wool and expanded polystyrene, before the assembly of the panel, connected by means of clamps to unite the two wooden frames with rock wool and expanded polystyrene.

4. The wall in compound panels for pre-fabricated construction according to claim 1, comprising a glass wool plate made through an extrusion process, in which the raw material, consisting of gel coat or pigment, low viscosity polyester resin with tri-hydrated alumna (aluminum oxide) and glass wool is dispensed over a polyester film which slides on a flat surface. The components of the raw material are dispensed in different phases over the polyester film, and after that, another polyester film is placed on top of them; in the next phase all the materials are compacted by means of cylinders that determine the thickness of the plate. After the material is compacted, the plates travel a certain distance over a heated table to complete the cure, transforming the “sandwich” in a rigid plate.

5. The wall in compound panels for pre-fabricated construction comprising the transformation of the plates and into panels, adding a core and performing a vacuum gluing or pressing process over the materials; the process starts with the sandpapering of the internal faces of the two plates and which will be glued together; the glass wool plate with the adhesive is placed in the press, followed by the core composed of the wood and, rock wool ribs, internal panel in rock wool and expanded polystyrene, then the set is completed with the second glass wool plate, and finally, the panel is submitted to vacuum for the pressing and gluing operations.
